(19) United States
(12) Patent Application Publication
(10) Pub. No.: US 2005/0046645 A1
(43) Pub. Date: Mar. 3, 2005

(54) Autoscaling

(76) Inventors: Pierre Felix Breton, Chambly (CA); Xavier Robitaille, Sakyo-ku (JP)

Correspondence Address: MOSER, PATTERSON & SHERIDAN, L.L.P., 3040 POST OAK BOULEVARD, SUITE 1500, HOUSTON, TX, 77056, US

(21) Appl. No.: 10/897,041

(22) Filed: Jul. 22, 2004

Related U.S. Application Data
(60) Provisional application No. 60/489,717, filed on Jul. 24, 2003.

(51) Int. Cl. G06T 15/10

(52) U.S. Cl. 345/660

(57) ABSTRACT

A method of scaling motion data input is provided in a system for interacting with objects, in a three-dimensional volume. The system includes a viewport onto which a two-dimensional image of the volume is displayed. A user provides motion input data to translate the volume or an object within the volume. A distance between a target and a portion of the viewport is calculated, and a scaling factor, based on the distance is calculated. The motion input data is incremented according to the scaling factor.

### CROSS-REFERENCE TO RELATED APPLICATIONS

This application claims benefit of U.S. provisional patent application Ser. No. 60/489,717, filed Jul. 24, 2003, which is herein incorporated by reference.

### BACKGROUND OF THE INVENTION

1. Field of the Invention

The present invention relates to a system and method for scaling user interaction within a three-dimensional scene configured with a viewport.

2. Description of the Related Art

Systems are known with which to create and interact with three-dimensional objects or groups thereof. Artists may use such systems to create and interact with a character object, or architects may use such systems to create and interact with building objects, or engineers may use such systems to create and interact with machinery and/or parts objects. In each instance, the above interactive process of creating and interacting with three-dimensional objects or groups thereof is known to those skilled in the art as 3D object modelling. An example of such a system is 3D Studio Max™ provided by Discreet Inc. of San Francisco, Calif.

At any time during the modelling process, interaction between the user and one or a plurality of 3D objects is performed through a viewport of said system, which is a two-dimensional window into the three-dimensional volume, also known to those skilled in the art as a scene or the world, within which said objects are defined and represented and onto which the portion of said scene intersecting the viewport frustum is rasterized.

In known systems, functions are provided for users to “navigate” within the scene and/or around objects thereof, for instance to observe then edit the positioning of 3D objects relative to one another within said scene, or even to edit shape, colour or texture properties of any of said 3D objects themselves. Such functions configure the above-described viewport with the functionality of a camera within the 3D volume of the scene, which may thus be panned, dollied and so on upon said user providing navigation input data, such that said user may in effect translate (for instance “zooming in” on a particular portion of the scene or a 3D object thereof) and/or rotate and/or scale relative to said scene and/or object: the respective geometries of the scene and any 3D object therein are transformed by said translation, rotation and scaling functions according to said user input data relative to said viewport.

However, a problem afflicting the above-described navigation arises out of the scale of a scene. Upon creating a scene for modelling objects therein, a user has to specify a scale in which system units of measure are defined in terms of imperial or metric units of measure, i.e. wherein one system unit is for instance defined as one meter or one mile. Within this context, transformation functions (for instance to perform the above scene navigation) are usually designed for processing user input data in terms of increments defined as the above-described system units, such that the inputting of motion input data by a user for transforming the scene relative to the viewport transforms said scene in increments of system unit irrespective of the scale of said scene.

In the example of a scene wherein a city has been modelled, complete with buildings models having door models themselves configured with doorknob models, wherein said city scene is for instance two kilometers wide by two kilometers long and a system unit is defined as a centimeter (one hundredth of a meter or one hundred-thousandths of a kilometer) because of the intricacy requirement of modelling buildings down to doorknobs, a user wanting to translate said viewport from the edge of the city scene closer to a particular building located a kilometer away would have to provide input data transforming scene and objects relative to said viewport by increments of one centimeter, i.e. wherein the camera is travelling one hundred-thousandths of a kilometer per unit of input data, thus wherein one hundred-thousand units of input data must be provided to achieve the required translation.

Having regard to the increasing scale of scenes numbering hundreds or even thousands of 3D objects as well as the increasing intricacy required of 3D models for inclusion in various applications including architectural development, engineering research or interactive entertainment, performing transformations within the above-described systems to facilitate scene navigation and object interaction therein severely hampers a user's workflow and thus unnecessarily increases the cost of modelling 3D objects or even entire scenes.

### SUMMARY OF THE INVENTION

The present invention involves scaling motion input data received by a system for interacting with objects in a three-dimensional volume configured with an orthogonal reference co-ordinate system. The system includes a viewport onto which a two-dimensional image of the volume is displayed. A user provides motion input data to translate the volume or an object within the volume. A distance between a target and a portion of the viewport is calculated, and a scaling factor, based on the distance is calculated. The motion input data is incremented according to the scaling factor.

Various embodiments of a system and method of the invention for scaling motion input data during application of a transformation to an object include identifying a target within the volume, calculating a distance between the target and a position within a viewport, the viewport displaying a two dimensional projection of the volume, calculating a scaling factor based on the distance, receiving motion input data, and processing the motion input data based on the scaling factor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a system for interacting with three-dimensional objects, according to one embodiment of the present invention;

FIG. 2 illustrates a scene configured with an orthogonal reference co-ordinate system and three-dimensional objects therein, processed by the system shown in FIG. 1 configured with a viewport, according to one embodiment of the present invention;

FIG. 3 details the hardware components of the computer system shown in FIGS. 1 and 2, including a memory, according to one embodiment of the present invention;

FIG. 4 details the processing steps according to which a user operates the system shown in FIGS. 1 to 3, including a step of interacting with a scene such as shown in FIG. 2, according to one embodiment of the present invention;

FIG. 5 details the contents of the memory shown in FIG. 3 after performing the step of loading or creating a scene shown in FIGS. 2 or 4, including said application, according to one embodiment of the present invention;

FIG. 6 further details the processing step shown in FIG. 4 according to which the user interacts with a scene such as shown in FIG. 2, including steps of calculating a distance, calculating a scaling factor and processing motion input data, according to one embodiment of the present invention;

FIG. 7 further details the processing step shown in FIG. 6 according to which a distance is calculated, according to one embodiment of the present invention;

FIG. 8 illustrates the distance which is calculated between the viewport shown in FIGS. 2 and 7 and a target according to the calculating step of FIGS. 6 and 7, according to one embodiment of the present invention;

FIG. 9 illustrates the distance which is calculated between the viewport shown in FIGS. 2 and 7 and an object according to the calculating step of FIGS. 6 and 7, according to one embodiment of the present invention;

FIG. 10 details an alternative embodiment of the processing step shown in FIG. 4 according to which the user interacts with a scene such as shown in FIG. 2, including further steps of selecting an object and calculating a distance thereto, according to one embodiment of the present invention;

FIG. 11 further details the processing step shown in FIG. 10 according to which a distance to an object is calculated, according to one embodiment of the present invention;

FIG. 12 illustrates the distance which is calculated between the viewport shown in FIGS. 2, 8 and 9 and an object according to the calculating step of FIGS. 10 and 11, according to one embodiment of the present invention;

FIG. 13 further details the processing step shown in FIGS. 6 and 10 according to which a scaling factor is calculated, according to one embodiment of the present invention;

FIG. 14 further details the processing step shown in FIGS. 6 and 10 according to which motion input data is processed, according to one embodiment of the present invention;

FIG. 15 shows the viewport of FIGS. 2, 7 to 9, 11 and 12 wherein the scene shown in FIGS. 2, 5, 8, 9 and 12 has been transformed in response to the application shown in FIG. 5 processing user motion input data as described in FIG. 14, in order to close in on a particular building object, according to one embodiment of the present invention;

FIG. 16 shows the viewport of FIG. 15, wherein the transformed scene shown in FIG. 15 has been further transformed in response to the application shown in FIG. 5 processing user motion input data in order to close in on a doorknob object of the building object shown in FIG. 15, according to one embodiment of the present invention; and

FIG. 17 shows the viewport of FIGS. 15 and 16, wherein the transformed scene shown in FIGS. 15 and 16 has been further transformed in response to the application shown in FIG. 5 processing user motion input data in order to rotate around the doorknob object in FIG. 16, according to one embodiment of the present invention.

### DETAILED DESCRIPTION

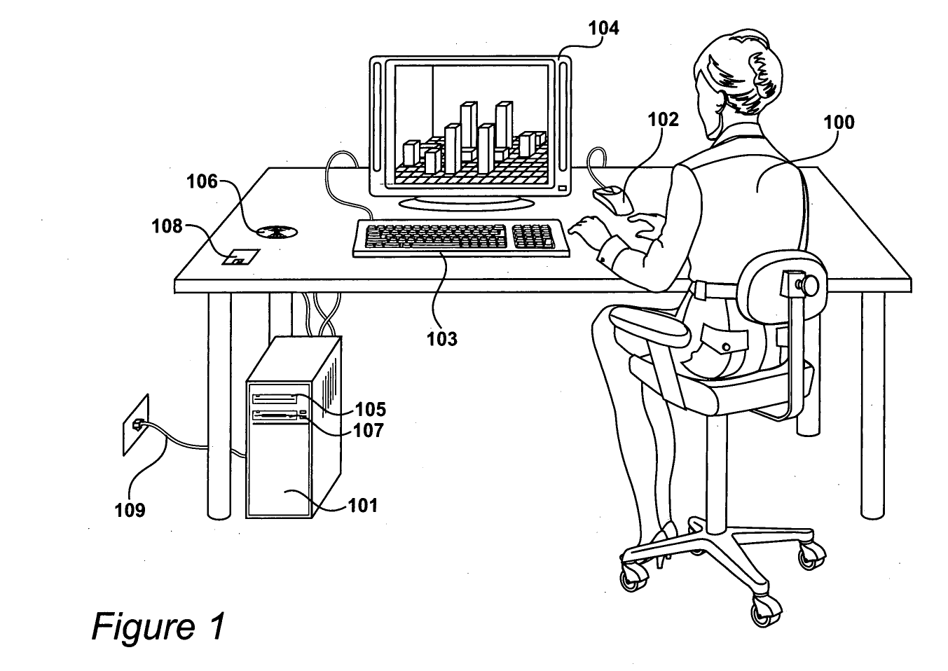

FIG. 1 shows a system for interacting with three-dimensional objects, including a video display unit, according to one embodiment of the present invention.

In the system shown in FIG. 1, instructions are executed upon a graphics workstation operated by an artist 100, the architecture and components of which depends upon the level of processing required and the size of objects being considered. Examples of graphics-based processing systems that may be used for very-high-resolution work include an ONYX II manufactured by Silicon Graphics Inc, or a multiprocessor workstation 101 manufactured by IBM Inc.

The processing system 101 receives motion data from artist 100 by means of a first user data input device 102 which, in the example, is a mouse. The processing system 101 also receives alphanumerical data from artist 100 by means of another user data input device 103 which, in the example, is a computer system keyboard of a standard alpha numeric layout. Said processing system 101 receives motion and alphanumerical data inputted by user 100 in response to visual information received by means of a visual display unit 104. The visual display unit 104 displays images including three-dimensional objects, menus and a cursor and movement of said cursor is controlled in response to manual operation of said user input device 102.

The processing system 101 includes internal volatile memory in addition to non-volatile bulk storage. System 101 includes an optical data-carrying medium reader 105 to allow executable instructions to be read from a removable data-carrying medium in the form of an optical disk 106, for instance a DVD-ROM. In this way, executable instructions are installed on the computer system for subsequent execution by the system. System 101 also includes a magnetic data-carrying medium reader 107 to allow object properties and data to be written to or read from a removable data-carrying medium in the form of a magnetic disk 108, for instance a floppy-disk or a ZIP™ disk.

System 101 is optionally connected to a Gigabit-Ethernet network 109 to similarly allow executable instructions and object properties and/or data to be written to or read from a remote network-connected data storage apparatus, for instance a server or even the Internet.

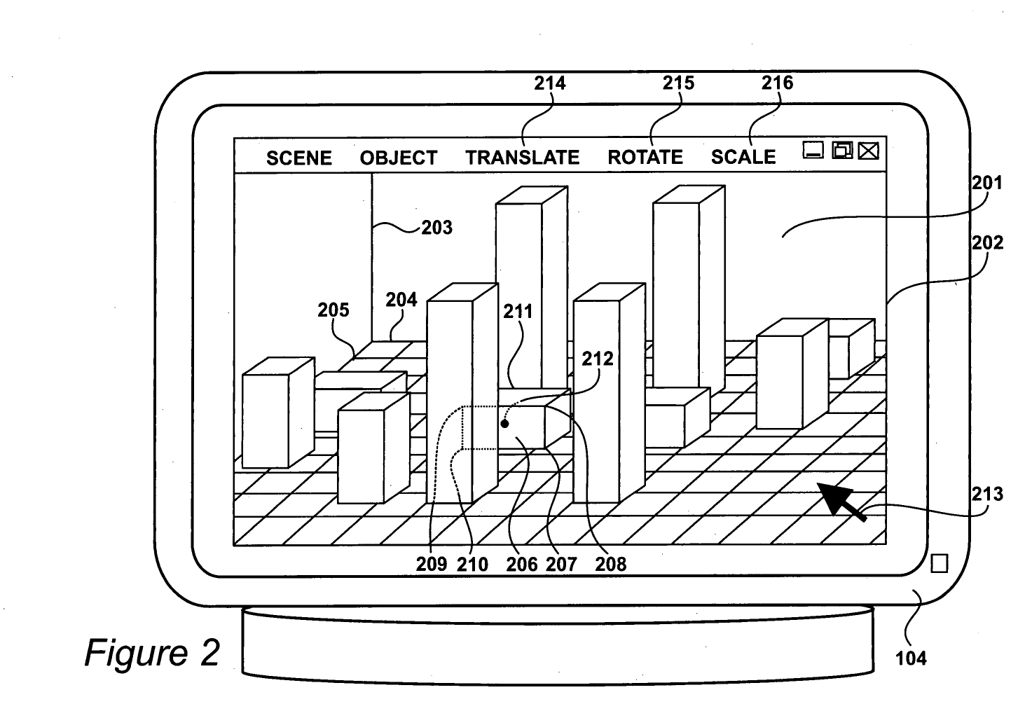

FIG. 2 shows an example of a volume containing three-dimensional objects processed with system 101 and interacted therewith by user 100, according to one embodiment of the present invention.

A volume 201 is shown in a viewport 202 displayed on the Liquid Crystal Display (LCD) component of VDU 104. Said volume 201 is known to those skilled in the art as a scene and is configured by system 101 with a x, y and z three-dimensional orthogonal reference co-ordinate system (RCS): the height 203 of said scene is defines by a vertical axis (Y), the breadth 204 of said scene is defined by a longitudinal axis (X) and the depth 205 of said scene is defined by a transversal axis (Z). The transformation by means of rotation, scaling and/or translation of scene 201 may thus be performed in relation to the scene orthogonal RCS. In the example, scene 201 portrays a city having buildings. The portion of scene 201 observable within the view frustrum of viewport 202 is rasterized in two x, y dimensions for output to VDU 104.

3D objects are defined by system 101 as a plurality of vertices having respective x, y and z co-ordinates within the RCS 203, 204, 205 of volume 201. Said vertices define polygons, such as polygon 206 defined by vertices 207 to 210, the grouping of which defines a three-dimensional object, in the example a building object 211.

Object 211 is itself configured with a x, y and z three-dimensional orthogonal reference co-ordinate system (RCS), wherein the geometrical center, or pivot 212 of said object is the origin (0, 0, 0) of said object orthogonal RCS: the height of said object defines a vertical axis (Y), the breadth of said object defines a longitudinal axis (X) and the thickness of said object defines a transversal axis (Z). The transformation by means of rotation, scaling and/or translation of object 211 within scene 201 may thus be performed either in relation to the scene orthogonal RCS or the object orthogonal RCS itself.

Optional selection by user 100 of any of said 3D objects with a pointer 213 activated by mouse 102 and subsequent input of two-dimensional motion data upon said mouse 102 results in said input data being processed by system 101 for transforming the geometry of said selected object 211 or even the entire scene 201.

For instance, if user 100 only requires to modify the geometry of object 211 within scene 201, also known to those skilled in the art as the pose of the object, by means of selecting said object then translating, rotating or scaling said object, the view frustrum of viewport 202 does not change and only the object is transformed. Alternatively, if user 100 requires to observe the city, i.e. scene 201, from a different point of view, by means of translating, rotating or scaling said scene relative to viewport 202, then the portion of scene 201 observable within the view frustrum of viewport 202 does change and the entire scene, including the objects therein are transformed. Said translation, rotation and scaling transformations may be interactively selected by user 100 with respectively translating said pointer 213 over portions 214 (“translate”), 215 (“rotate”) and 216 (“scale”) of viewport 202.

Said transformed object is subsequently rasterized onto viewport 202 or, if the scene itself is transformed, then all of the objects therein are similarly transformed and rasterized onto viewport 202.

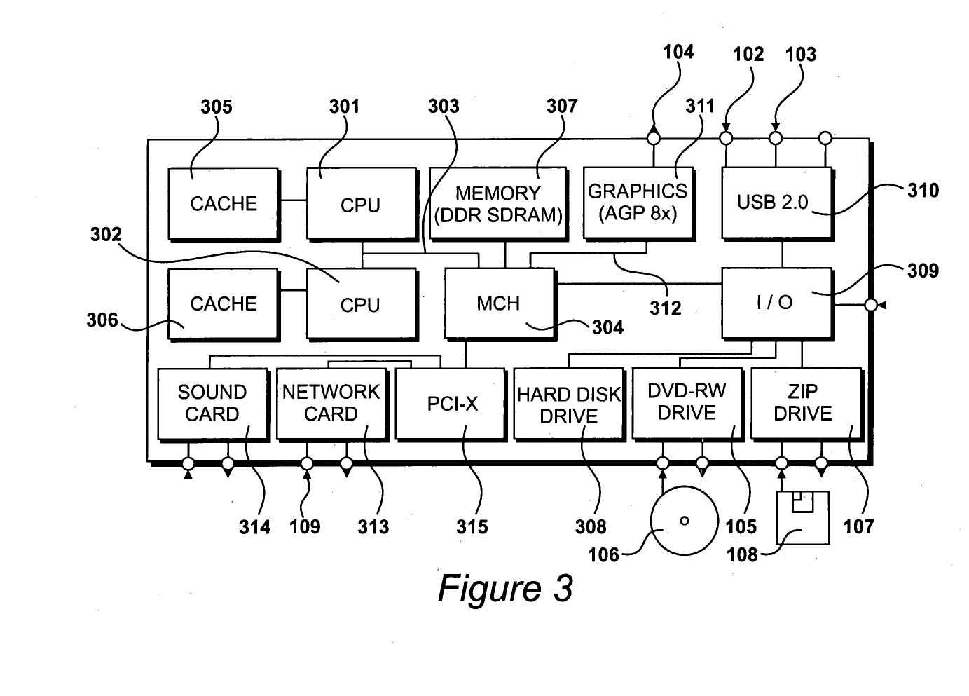

FIG. 3 shows the components of computer system 101, according to one embodiment of the present invention. In some embodiments of the present invention, said components are based upon Intel® E7505 hub-based Chipset.

The system includes two Intel® Pentium™ Xeon™ DP central processing units (CPU) 301, 302 running at three Gigahertz, which fetch and execute instructions and manipulate data with using lntel®'s Hyper Threading Technology via an Intel® E7505 533 Megahertz system bus 303 providing connectivity with a Memory Controller Hub (MCH) 304. CPUs 301, 302 are configured with respective high-speed caches 305, 306 comprising at least five hundred and twelve kilobytes, which store frequently-accessed instructions and data to reduce fetching operations from a larger memory 307 via MCH 304. The MCH 304 thus co-ordinates data flow with a larger, dual-channel double-data rate main memory 307, which is between two and four gigabytes in data storage capacity and stores executable programs which, along with data, are received via said bus 303 from a hard disk drive 308 providing non-volatile bulk storage of instructions and data via an Input/Output Controller Hub (ICH) 309. Said ICH 309 similarly provides connectivity to DVD-ROM re-writer 105 and ZIP™ drive 107, both of which read and write data and instructions from and to removable data storage media 106, 108. Finally, ICH 309 provides connectivity to USB 2.0 input/output sockets 310, to which the keyboard 103 and mouse 102 are connected, all of which send user input data to system 101.

A graphics card 311 receives graphics data from CPUs 301, 302 along with graphics instructions via MCH 304. Said graphics accelerator 311 is preferably coupled to the MCH 304 by means of a direct port 312, such as the direct-attached advanced graphics port 8X (AGP 8X) promulgated by the Intel® Corporation, the bandwidth of which exceeds the bandwidth of bus 303. Preferably, the graphics card 311 includes substantial dedicated graphical processing capabilities, so that the CPUs 301, 302 are not burdened with computationally intensive tasks for which they are not optimised.

Network card 313 provides connectivity to the Ethernet network 109 by processing a plurality of communication protocols, for instance a communication protocol suitable to encode and send and/or receive and decode packets of data over a Gigabit-Ethernet local area network. A sound card 314 is provided which receives sound data from the CPUs 301, 302 along with sound processing instructions, in a manner similar to graphics card 311. Preferably, the sound card 314 includes substantial dedicated digital sound processing capabilities, so that the CPUs 301, 302 are not burdened with computationally intensive tasks for which they are not optimised. Preferably, network card 313 and sound card 314 exchange data with CPUs 301, 302 over system bus 303 by means of Intel®'s PCI-X controller hub 315 administered by MCH 304.

The equipment shown in FIG. 3 constitutes a typical workstation comparable to a high-end IBM™ PC compatible.

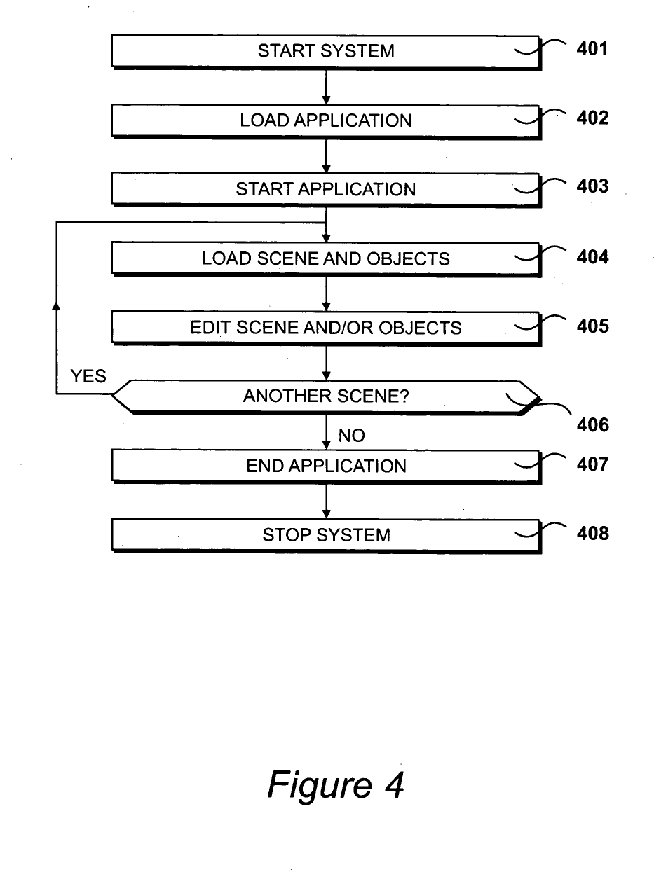

FIG. 4 shows the processing steps according to which artist 100 may operate the system shown in FIGS. 1 to 3, according to one embodiment of the present invention

At step 401, user 100 switches on the system and, at step 402, an instruction set is loaded from hard disk drive 308 or DVD ROM 106 by means of the optical reading device 105 or magnetic disk 108 by means of magnetic reading device 107, or even a network server connected to network 109 and accessed by means of network card 313. Upon completing the loading of step 402 of instructions set into memory 207, CPUs 301, 302 may start processing said set of instructions, also known as an application, at step 403.

At step 404, user 100 may select a scene, such as scene 201, for loading into memory 307 from hard disk drive 308 or DVD ROM 106 by means of the optical reading device 105 or magnetic disk 108 by means of magnetic reading device 107, or even a network server connected to network 109 and accessed by means of network card 313. When said loading operation is complete, said user 100 may then edit said scene or any 3D object therein according to the requirements of his or her workflow at step 405. Alternatively, user 100 may want to create a new scene and objects therein, such that the loading operation of step 404 is not required but the editing operation of step 405 may be performed nonetheless.

A question is eventually asked at the next step 406, as to whether the user 100 should edit another scene, thus require loading at step 404 for interacting therewith. If the question of step 406 is answered positively, control thus returns to the question of step 404 for selection of a scene. Alternatively, the question of step 406 is answered negatively, signifying that artist 100 does not require the functionality of the application loaded at step 402 anymore and can therefore terminate the processing thereof at step 407. Artist 100 is then at liberty to eventually switch off system 101 at step 408.

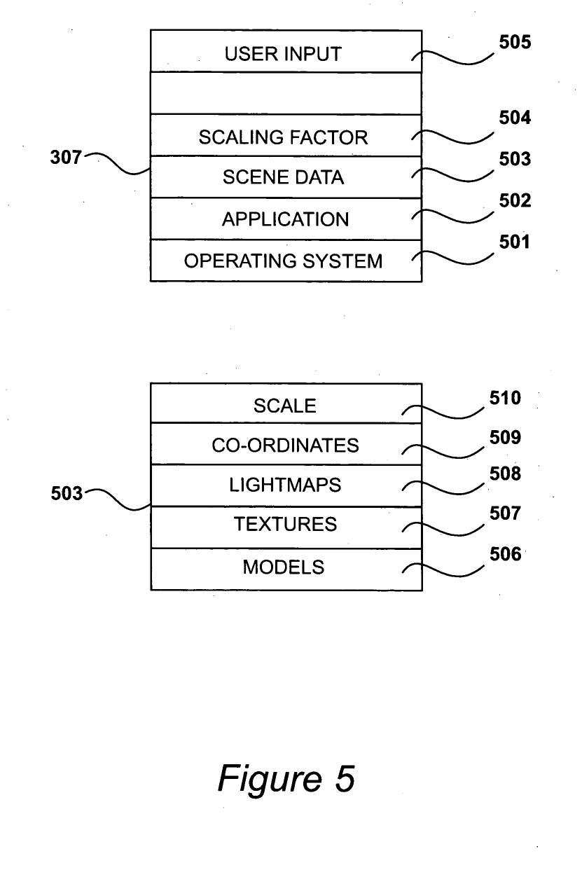

FIG. 5 shows the contents of main memory 307 subsequently to the loading step 404 of a scene, or the creation thereof, according to one embodiment of the present invention.

An operating system is shown at 501 which comprises a reduced set of instructions for CPUs 201, 202 the purpose of which is to provide system 101 with basic functionality. Examples of basic functions include for instance access to files stored on hard disk drive 208 or DVD/CD-ROM 106 or ZIP(™) disk 108 and management thereof, network connectivity with a network server and the Internet over network 109, interpretation and processing of the input from keyboard 103 and mouse 102. In the example, the operating system is Windows XP(™) provided by the Microsoft corporation of Redmond, Calif., but it will be apparent to those skilled in the art that the instructions according to the present invention may be easily adapted to function under different other known operating systems, such as IRIX(™) provided by Silicon Graphics Inc. or LINUX, which is freely distributed.

An application is shown at 502 which comprises the instructions loaded at step 402 that enable the image processing system 101 to perform steps 403 to 407 according to the invention within a viewport 202 displayed on VDU 104. Application 502 comprises instructions processable by CPUs 201, 202 and may take the form of a software product obtained on a data-carrying medium such as optical disc 106 or magnetic disc 108 or my be downloaded as one or a plurality of data structures by means of network connection 109 from a server or the Internet.

Application data comprises various sets of user input-dependent data and user input-independent data, which are shown as scene data 503, scaling factor 504 and user input data 505, wherein application 502 processes scene data 503 according to scaling factor 504 and user input data 505.

Said scene data 503 defines and references the scene attributes and properties as well as various types of 3D objects therein with their respective attributes. A number of examples of scene data 503 are provided for illustrative purposes only and it will be readily apparent to those skilled in the art that the subset described is here limited only for the purpose of clarity. Said scene data 503 may include 3D objects 506 loaded according to step 404 and/or edited according to step 405.

Said scene data 503 may also include 3D object attributes such as texture files 507 applied by graphics card 311 to polygons such as polygon 206. In the example, scene data 504 also includes lightmaps 508, the purpose of which is to reduce the computational overhead of graphics card 311 when rendering the scene with artificial light sources. Scene data 503 includes three-dimensional location references 509, the purpose of which is to reference the position of the scene objects edited at step 405 therein in relation to its RCS. Scene data 503 finally includes scene scale data 510, the purpose of which is to define the unit of reference in relation to its RCS for the scene objects 506 and any editing thereof according to step 405.

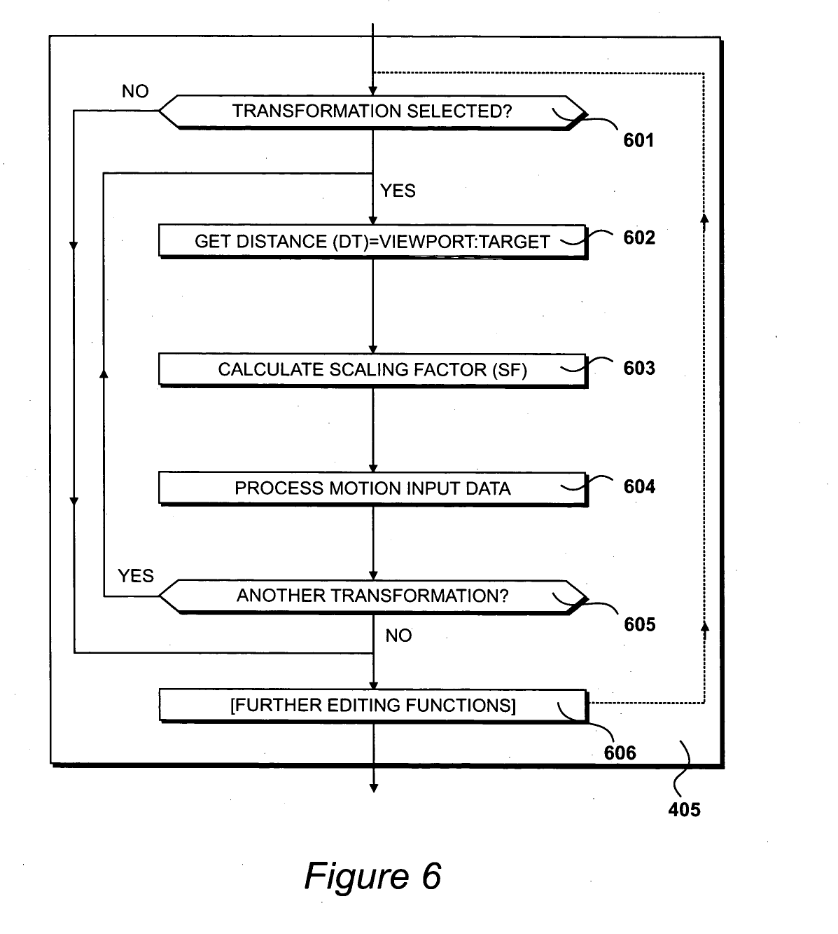

FIG. 6 shows the processing step shown in FIG. 4 according to which the user interacts with a scene such as shown in FIG. 2, according to one embodiment of the present invention.

A first question is asked at step 601, as to whether user 100 has selected a transformation as described in FIG. 2. If the question of step 601 is answered positively, application 502 calculates a distance (DT) between viewport 202 and a target within scene 201. Particularly, application 502 calculates a distance between the pointer 213 within viewport 202 and said target. Upon calculating said distance (DT), application 502 then calculates a scaling factor (SF) at step 603.

At step 604, said scaling factor (SF) is used by application 502 to process user input 505 as transformation input data, wherein said scaling factor (SF) is set as input data increment. A second question is asked at step 605 as to whether user 100 has selected another transformation, again as described in FIG. 2, i.e. if an interrupt command was received to the effect that a viewport portion 214, 215 or 216 different from the initial selection at question 601 has been selected.

If the question of step 605 is answered positively, control proceeds to step 602, such that the distance (DT) upon which the scaling factor (SF) is subsequently calculated at step 603 may be updated, and so on and so forth. Alternatively, the question of step 605 is answered negatively and, as would be the case if the question of step 601 was initially answered negatively, user 100 may perform various other types of scene and/or object editing functions featured by application 502 at the next step 606, which are not herein described for the purpose of not necessarily obscuring the present description but which will be familiar to those skilled in the art. At any time during said further scene and/or object editing, user 100 may nonetheless again select transformation functions, whereby control would be returned to the question of step 601.

FIG. 6 shows the processing step shown in FIG. 6 according to which a distance is calculated between the viewport 202 and a scene target, according to one embodiment of the present invention.

At step 701, application 502 constrains the view axis extending between pointer 213 of viewport 202 and the target within scene 201 to the geometry of the viewport frustrum, i.e. the aperture of the viewport field-of-view expressed as an angle. At step 702, application 502 reads the (X,Y) screen co-ordinates of pointer 213 within viewport 202 in order to calculate the three-dimensional (X,Y,Z) co-ordinates of said pointer relative to the scene orthogonal RCS at the next step 703.

At step 704, application 502 then calculates the delta of said pointer 213 within scene 201 as a projection of its (X,Y,Z) scene co-ordinates according to the aperture geometry onto the first geometric surface within scene 201 said view axis intersects. At the next step 705, application 502 calculates the geometric center, or pivot point, three-dimensional (X,Y,Z,) co-ordinates of the delta of step 704, such that a vector length (L1) may then be calculated at step 706, wherein said three-dimensional vector originates from pointer 213 expressed as (X,Y,Z) scene co-ordinates and ends at said pivot (X,Y,Z,) scene co-ordinates. Said length (L1) is thus set by application 502 as the target distance (DT) in scene scale units at step 707.

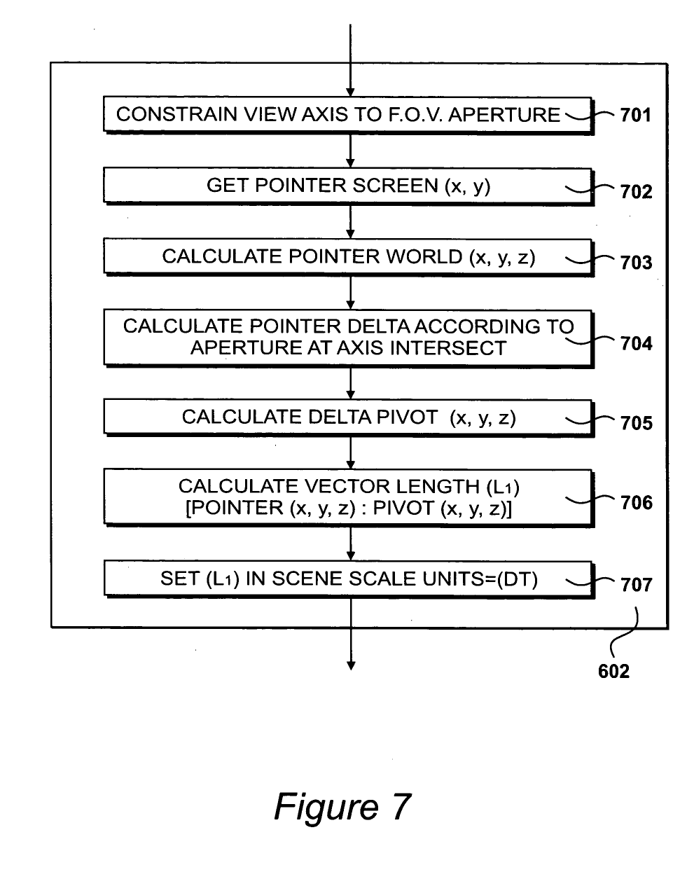

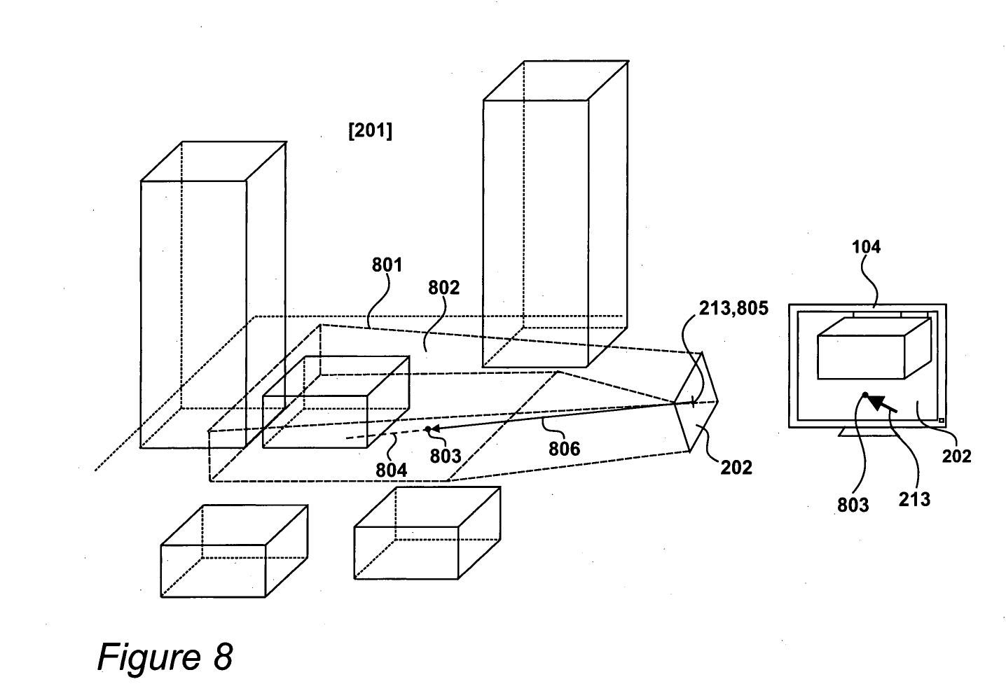

FIG. 8 shows the distance (DT) calculated at steps 701 to 706 between the viewport 202 shown in FIGS. 2 and 7 and the scene target, according to one embodiment of the present invention.

Viewport 202 is figuratively represented in perspective, configured with a view frustrum 801 encompassing a portion 802 of scene 201, wherein said portion 802 includes target 803. According to the present description, said target 803 is the pivot, or geometrical center, of the delta of said pointer 213 at the intersection of a viewing axis 804 extending therefrom with any geometrical boundary within scene 201 which, in the example, is the “floor”, or XZ plane thereof.

The distance (DT) calculated at step 602 is thus the distance between the origin 805 of the viewing axis 804 extending between pointer 213 at viewport 202 and said target 803, wherein the orientation of said axis within scene 201 is constrained to the geometry of the field-of-view (FOV) defined by frustrum 801. A three-dimensional vector 806 is therefore derived at step 705, the length of which is the distance (DT) returned by processing step 602. In the example, the scale of scene 201 is in meters and said distance (DT) equals 2,000 scene scale units, thus two thousand meters.

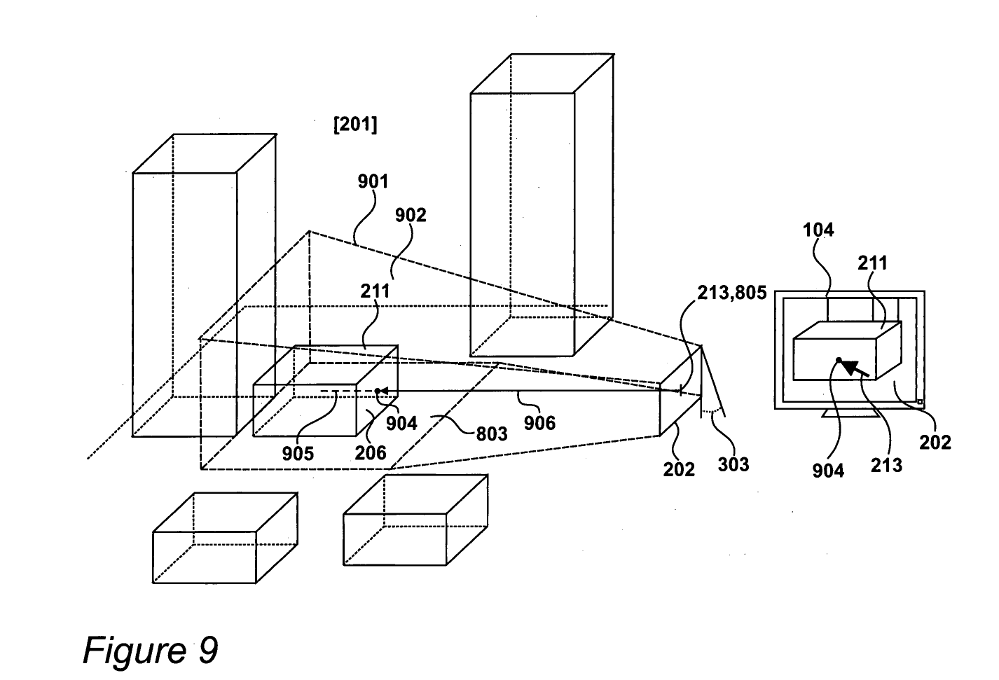

FIG. 9 shows the distance (DT) calculated at steps 701 to 706 between the viewport 202 shown in FIGS. 2 and 7 and the scene target, according to one embodiment of the present invention. The axis 804 intersects a 3D object which, in the example, is building 211.

Viewport 202 is again figuratively represented in perspective and configured with a view frustrum 901 encompassing a portion 902 of scene 201, wherein said frustrum 901 has been rotated by a few degrees in the vertical direction shown at 903. The target 904 is the pivot of the delta of pointer 213 at the intersection of viewing axis 905 extending therefrom with any geometrical boundary within scene 201 which, in the example, is now polygon 206 of building object 211.

The distance (DT) calculated at step 602 is thus the distance between the origin 805 of the viewing axis 905 extending between pointer 213 at viewport 202 and said target 904, wherein the orientation of said axis within scene 201 is still constrained to the geometry of the field-of-view (FOV) defined by frustrum 801. A three-dimensional vector 906 is therefore again derived at step 705, the length of which is the distance (DT) returned by processing step 602. In the example, the scale of scene 201 is in meters and said distance (DT) equals 2,200 scene scale units, thus two thousand and two hundred meters, as building 211 is 200 units of scene depth away from target 803.

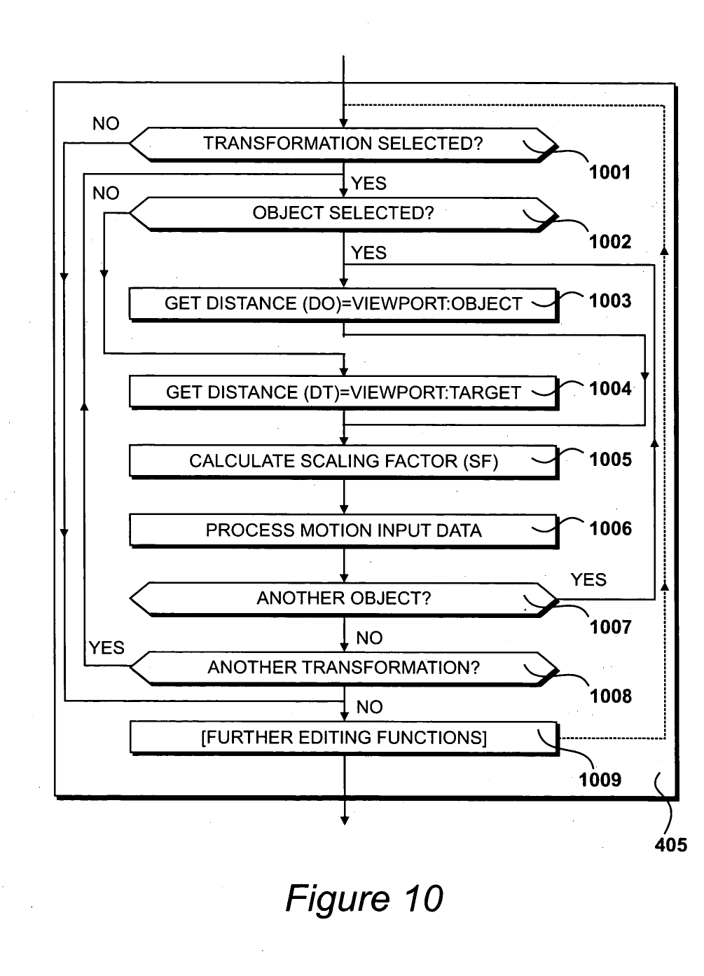

FIG. 10 shows an alternative embodiment of the processing step shown in FIG. 4 according to which the user interacts with a scene such as shown in FIG. 2, according to one embodiment of the present invention.

A first question is asked at step 1001, as to whether user 100 has selected a transformation as described in FIG. 2. If the question of step 1001 is answered positively, a second question is asked at step 1002 as to whether user 100 has selected an object within scene 201, for instance by means of translating pointer 213 within viewport 202 over the rasterization in pixels thereof and providing an interrupt command, such as a mouse click. If the question of step 1002 is answered positively, application 502 calculates a distance (DO) between viewport 202 and the selected object within scene 201. Particularly, application 502 calculates a distance between the pointer 213 within viewport 202 and said object. Alternatively, the question of step 1002 is answered negatively, whereby application 502 again calculates a distance (DT) between viewport 202 and a target within scene 201 at step 1004. Particularly, application 502 calculates a distance between the pointer 213 within viewport 202 and said target.

Upon calculating either of said distances (DO) or (DT), application 502 then calculates a scaling factor (SF) at step 1005. At step 1006, said scaling factor (SF) is used by application 502 to process user input 505 as transformation input data, wherein said scaling factor (SF) is set as input data increment. A third question is asked at step 1007, as to whether user 100 has selected another object for interaction therewith. If the question of step 1007 is answered positively, control returns to step 1003, such that the distance (DO) to said other selected object may be calculated and the scaling factor (SF) updated accordingly at step 1005 and so on and so forth.

Alternatively, the question of 1007 is answered negatively, whereby a fourth question is asked at step 1008, as to whether user 100 has selected another transformation, again as described in FIG. 2, i.e. if an interrupt command was received to the effect that a viewport portion 214, 215 or 216 different from the initial selection at question 1001 has been selected. If the question of step 1008 is answered positively, control proceeds to step 1002, such that user 100 may optionally select the same or a different object to effect further transformations.

Alternatively, the question at step 1008 is answered negatively and as would be the case if question 1001 was answered negatively, control proceeds to step 1009, user 100 may perform various other types of scene and/or object editing functions featured by application 502, which are not herein described for the purpose of not necessarily obscuring the present description but which will be familiar to those skilled in the art. At any time during said further scene and/or object editing, user 100 may nonetheless again select transformation functions, whereby control would be returned to the question of step 1001.

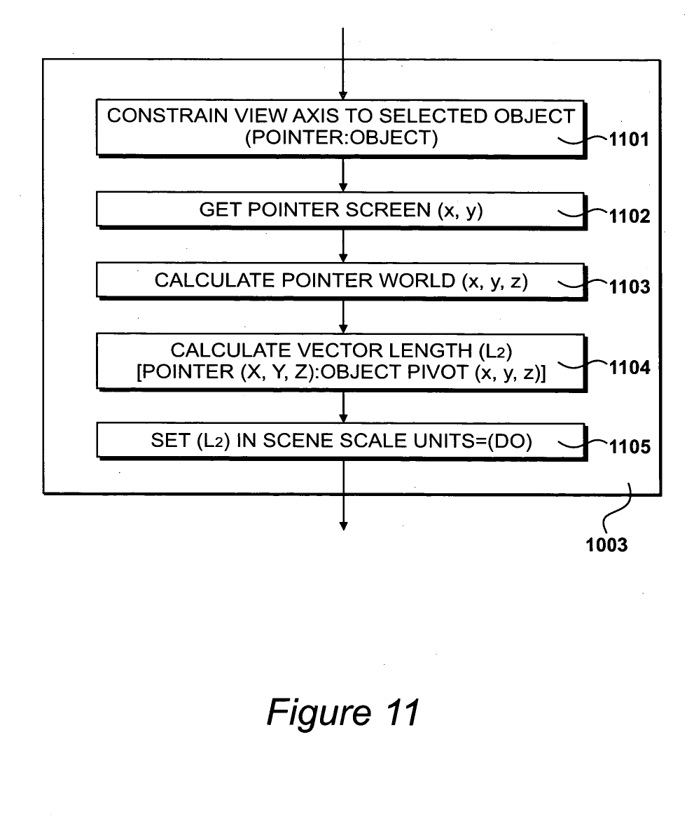

FIG. 11 shows the processing step shown in FIG. 10 according to which a distance to an object is calculated between the viewport 202 and an object, according to one embodiment of the present invention.

At step 1101, application 502 constrains the view axis extending between pointer 213 of viewport 202 and the selected object within scene 201 to said object. At step 1102, application 502 reads the (X,Y) screen co-ordinates of pointer 213 within viewport 202 in order to calculate the three-dimensional (X,Y,Z) co-ordinates of said pointer relative to the scene orthogonal RCS at the next step 1103, in a manner similar to steps 702, 703 respectively.

At step 1104, application 502 derives a vector length (L2), wherein said three-dimensional vector originates from pointer 213 expressed as (X,Y,Z) scene co-ordinates and ends at the pivot (X,Y,Z,) scene co-ordinates of said selected object. Said length (L2) is thus set by application 502 as the target distance (DO) in scene scale units at step 1105.

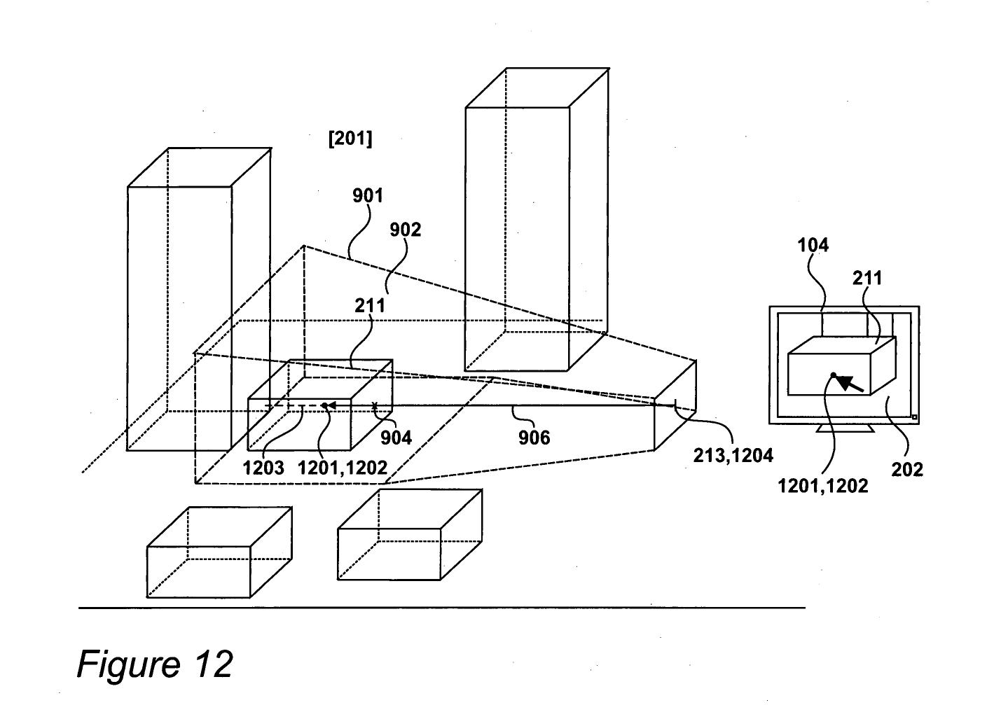

FIG. 12 shows the distance (DT) calculated at steps 1101 to 1105 between the viewport 202 shown in FIGS. 2, 7, 8 and 9 and an object within scene 201, according to one embodiment of the present invention. The 3D object is building 211 in the example.

Viewport 202 is again figuratively represented in perspective and configured with the same view frustrum 901 encompassing the same portion 902 of scene 201 shown in FIG. 9. The target 1201 is the pivot 1202 of object 211 at the intersection of viewing axis 1203 extending from pointer 213.

The distance (DO) calculated at step 1003 is thus the distance between the origin 1204 of the viewing axis 1203 extending between pointer 213 at viewport 202 and said target 1202, wherein the orientation of said axis within scene 201 is constrained to the geometry of the field-of-view (FOV) defined by frustrum 801. A three-dimensional vector 1205 is therefore derived at step 1104, the length of which is the distance (DO) returned by processing step 1003. In the example, the scale of scene 201 is in meters and said distance (DO) equals two thousand, two hundred and fifty scene scale units, thus two thousand, two hundred and fifty meters, as building 211 is one hundred scene units deep and its pivot 1202 is located at its center, thus fifty meters away from previous target 904.

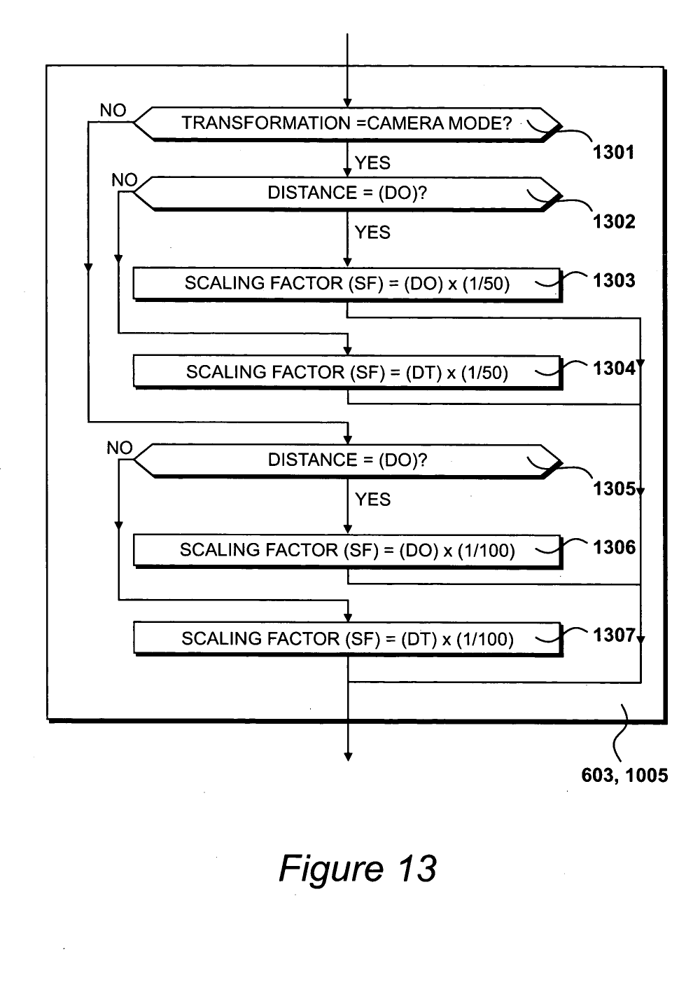

FIG. 13 shows the processing step shown in FIGS. 6 and 10 according to which a scaling factor is calculated, according to one embodiment of the present invention.

In the system of the preferred embodiment, translation, rotation and scaling transformations may be performed in any of two viewport modes. A first mode referred to as “camera” is preferably used by user 100 to “navigate” within scene 201, whereas a second mode referred to as “perspective” is preferably used by user 100 to accurately visualise objects therein at close range in order to perfect the modelling thereof.

A first question is asked at step 1301 as to whether the selected transformation of steps 601 or 1001 conforms to the “camera” viewport mode. If the question of step 1301 is answered positively, signifying that user 100 does not require a high level of accuracy for scene interaction purposes, a second question is asked at step 1302, as to whether the distance calculated to derive the scaling factor is a distance-to-object (DO). If the question of step 1302 is answered positively, said scaling factor is set as a fiftieth of said (DO) distance, at step 1303. Alternatively, if the question of step 1302 is answered negatively, signifying that the distance calculated to derive the scaling factor is a distance-to-target (DT), said scaling factor is set as a fiftieth of the (DT) distance at step 1304.

If, however, the question of step 1301 is answered negatively, the viewport mode is therefore “perspective”, wherein user 100 requires highly accurate interaction and control proceeds to a third question at step 1305, as to whether the distance calculated to derive the scaling factor is a distance-to-object (DO). If the question of step 1305 is answered positively, said scaling factor is set as one hundredth of said (DO) distance, at step 1306. Alternatively, If the question of step 1305 is answered negatively, signifying that the distance calculated to derive the scaling factor is a distance-to-target (DT), said scaling factor is set as one hundredth of the (DT) distance at step 1307.

The one fiftieth ratio and one hundredth ratio respectively used in steps 1303, 1304 and 1306, 1307 are used herein by way of example only and it will be appreciated by those skilled in the art that the present description is not limited thereto, as different such ratios may be more appropriate in some circumstances.

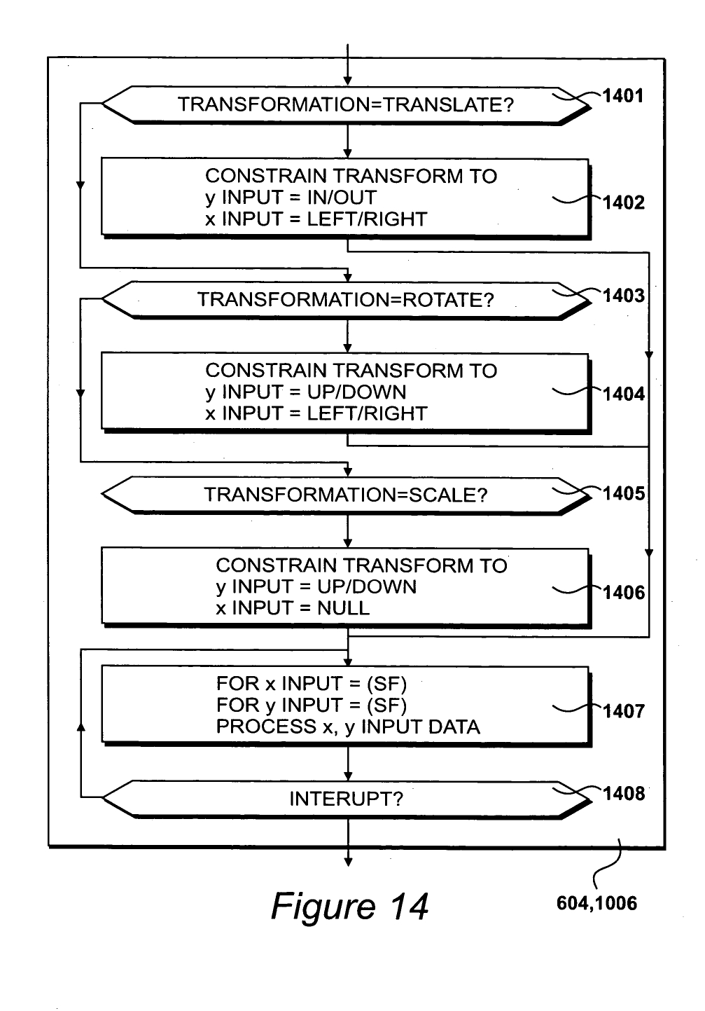

FIG. 14 shows the processing step shown in FIGS. 6 and 10 according to which motion input data is processed based on the calculated scaling factor described in FIG. 13, according to one embodiment of the present invention.

A first question is asked at step 1401 as to whether the transformation selected at either step 601, or 1001 is a translation. If the question of step 1401 is answered positively, application 502 constrains user input data preferably provided by means of two-dimensional input device 102 at step 1402 such that vertical motion imparted thereto translates viewport 202 into or out of scene 201, or closer to or away from a selected object therein, and horizontal motion imparted thereto translates viewport 202 along scene 201 following a direction perpendicular to viewing axes.

Alternatively, the question of step 1401 is answered negatively and a second question is asked at step 1403 as to whether the transformation selected at either step 601, or 1001 is a rotation. If the question of step 1403 is answered positively, application 502 constrains user input data preferably provided by means of two-dimensional input device 102 at step 1404 such that vertical motion imparted thereto rotates viewport 202 relative to the target pivot or the selected object pivot and horizontal motion imparted thereto rotates viewport 202 relative to the target pivot or the selected object pivot.

Alternatively, the question of step 1403 is answered negatively and a second question is asked at step 1405 as to whether the transformation selected at either step 601, or 1001 is scaling. If the question of step 1405 is answered positively, application 502 constrains user input data preferably provided by means of two-dimensional input device 102 at step 1406 such that vertical motion imparted thereto scales the target pivot or the selected object pivot relative to viewport 202 and horizontal motion imparted thereto is nulled.

Upon performing any of the constraining operations of steps 1402,1404 or 1406, application 502 then processes two-dimensional user input data 505 accordingly, wherein said input data is incremented as the scaling factor (SF) calculated according to either step 603 or 1005. Thereafter, a final question is asked at step 1408 as to whether an interrupt command has been received, for instance by means of user 100 effecting a mouse click for either selecting a different transformation or a different object. If the question of step 1408 is answered positively, control proceeds to the question of step 605 or the question of step 1007. Alternatively, the question of step 1408 is answered negatively and control returns to step 1407, wherein input data continuously provided by user 100 is processed by application 502 for transforming scene 201 and/or 3D objects therein.

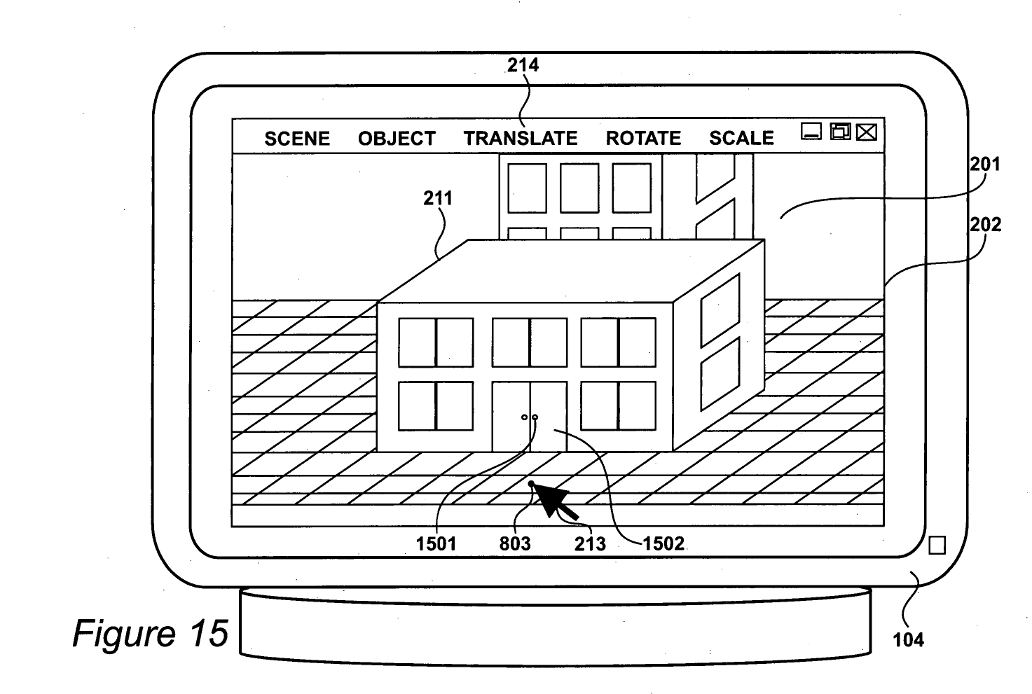

FIG. 15 shows the viewport of FIGS. 2, 7 to 9, 11 and 12 wherein the scene shown in FIGS. 2, 5, 8, 9 and 12 has been transformed, according to one embodiment of the present invention. The scene has been transformed in response to the application shown in FIG. 5 processing user motion input data as described in FIG. 14, in order to close in on a particular building object.

In the example, user 100 has loaded scene 201 including object 211 as described in FIG. 2 by means of loading said scene according to step 404, with a view to eventually edit a doorknob 3D model 1501 located on the entrance door 3D model 1502 of said object 211 at step 405. Upon completing said loading operation 404, user 100 is therefore presented with scene 201 within viewport 202 as shown in FIG. 2. User 100 therefore initially wishes to “zoom in” on the area in the vicinity of object 211, but does not yet select any of said objects 201, 1501 or 1502 as described in FIG. 10, for instance because they are not visible in the scene as shown in FIG. 2. It should nonetheless be readily apparent to those skilled in the art that the workflow described in FIG. 15 is for the purpose of illustrating the present teachings only and that user 100 may select object 211 in the situation depicted therein, whereby the teachings of FIG. 10 would apply henceforth, as will be further described in the present description.

According to the present description, user 100 selects a “translate” portion 214 of viewport 202, which is the graphical user interface (GUI)of application 502. Alternatively, said “translate” transformation selection is performed by means of activating a particular key of keyboard 103, wherein the association of said transformation function to said key is known as a “hotkey”.

According to the present description still, pointer 213 is located a few pixels below the base of object 211 relative to the (X,Z) plane 204, 205 of scene 201, as shown in FIG. 8, such that a target 803 is calculated therefrom substantially as described in FIGS. 7 and 8. As previously described, the distance of 3D vector 806 is two thousand metres. According to the description of step 603, the question of step 1301 is answered positively because a high level of accuracy is not yet required, whereby the question of step 1202 is also answered positively since user 100 has not selected any object with pointer 213 for the purpose of said scene navigation. The scaling factor (SF) is therefore calculated as one fiftieth of the two thousand metres distance, i.e. forty scene scale units or forty metres. Thereafter, according to the description of step 604, the question of step 1401 is answered positively in regard of the previous “translate” 214 selection such that input data provided by user 100 by means of mouse 102 is constrained according to the parameters described at step 1402. User 100 thus imparts a vertical motion to mouse 102 (the y axis thereof) and said input data is incremented according to said (SF) value of forty metres. In effect, viewport 202 is translated towards target 803 near object 211 along vector 806 in increments of forty scene scale units, or forty metres, until such time as the scene has been transformed from the scene shown in FIG. 2 to the scene as shown in FIG. 15.

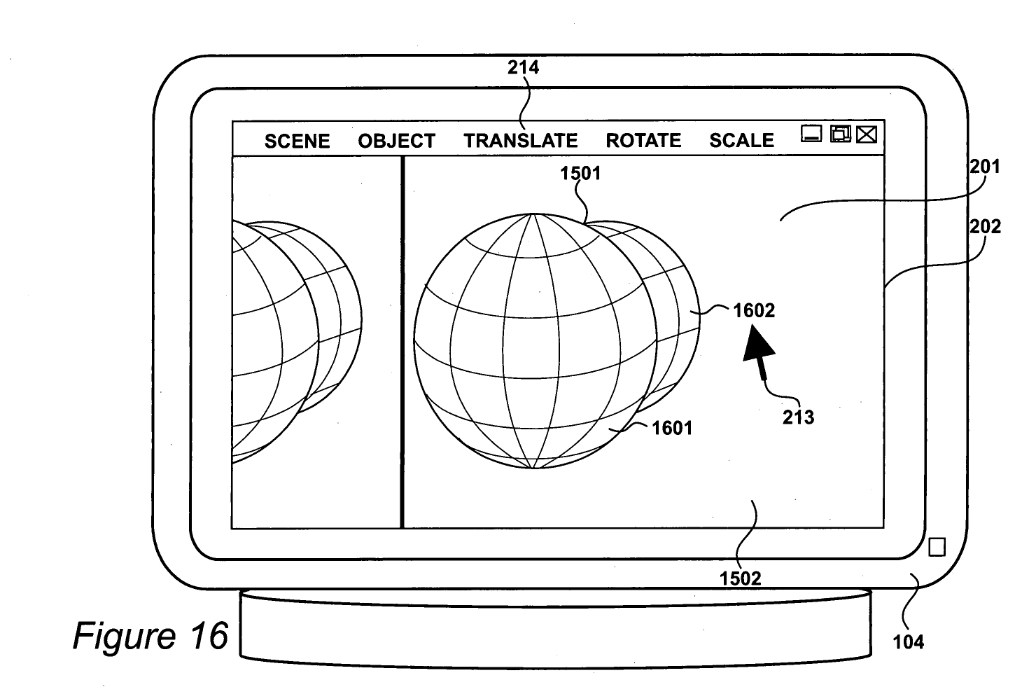

FIG. 16 shows the viewport of FIG. 15, wherein the transformed scene shown in FIG. 15 has been further transformed, according to one embodiment of the present invention. The scene is transformed in response to the application shown in FIG. 5 processing user motion input data in order to close in on doorknob object 1501 of the building object 211.

Having regard to the transformed scene shown in FIG. 15, user 100 now wishes to “zoom in” further on doorknob object 1501, which is visible. According to the present description, user 100 again selects a “translate” portion 214 of viewport 202, which is the graphical user interface (GUI) of application 502. Alternatively, said “translate” transformation selection is again performed by means of activating a particular key of keyboard 103, wherein the association of said transformation function to said key is known as a “hotkey”.

According to the present description still, pointer 213 is translated onto the pixels representing doorknob object 1501 rasterized onto viewport 202 and a selection input, for instance by means of a mouse click, as described in FIG. 12, such that a target such as target 1201 is calculated therefrom substantially as described in FIGS. 11 and 12. As previously described, the length of a 3D vector such as 3D vector 904 is calculated and, having regard to the fact that the viewport has been translated as described in FIG. 15, said distance is now only two hundred metres.

According to the description of step 1005, the question of step 1301 is again answered positively because a high level of accuracy is still not yet required to translate from the scene shown in FIG. 15 to the scene shown in FIG. 16. The question of step 1202 is however answered negatively since user 100 has selected object 1501 with pointer 213 for the purpose of said scene navigation. The scaling factor (SF) is therefore calculated as one fiftieth of the two hundred metre distance, i.e. four scene scale units or four metres. Thereafter, according to the description of step 1008, the question of step 1401 is answered positively in regard of the previous “translate” 214 selection such that input data provided by user 100 by means of mouse 102 is constrained according to the parameters described at step 1402. User 100 thus imparts a vertical motion to mouse 102 (the y axis thereof) and said input data is incremented according to said (SF) value of four metres. In effect, viewport 202 is translated towards the pivot of doorknob object 1501 along the 3D vector calculated at step 1104 in increments of four scene scale units, or four metres until such time as the scene has been transformed from the scene shown in FIG. 15 to the scene as shown in FIG. 16. User 100 can now observe that object 1501 comprises two 3D objects, a sphere 3D object 1601 mounted onto a cylinder 3D object 1602.

Application 502 has thus automatically scaled the extent of transformation according to the calculated scaling factor (SF), such that the inputting of motion data by user 100 for transforming the scene appears linear to said user: imparting the same amount of motion to the mouse 102 (i.e. the same amount of x and/or y increments) appears to the user to transform the scene by the same amount irrespective of how large or small the extent of the field-of-view of the viewport is.

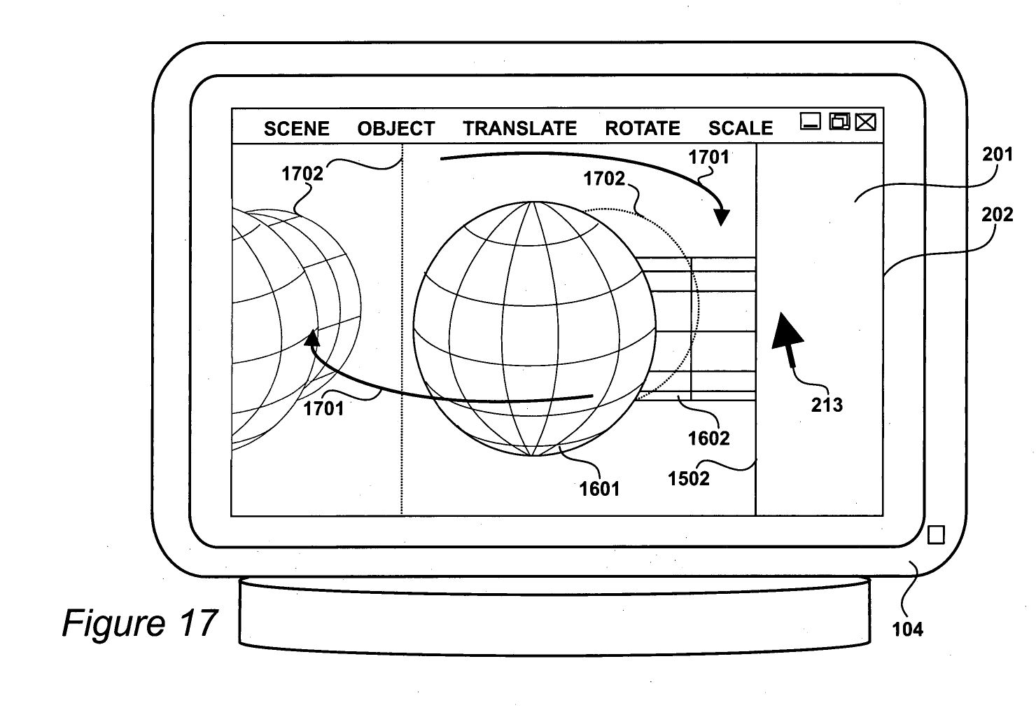

FIG. 17 shows the viewport of FIGS. 15 and 16, according to one embodiment of the present invention, wherein the transformed scene shown in FIGS. 15 and 16 has been further transformed in response to the application shown in FIG. 5 processing user motion input data in order to rotate around the doorknob object.

Having regard to the transformed scene shown in FIG. 16, the scale of the scene is now appropriate for user 100 to edit the cylinder 3D object 1602 of doorknob object 1501, thus said user requires high accuracy of movement and, in the example, requires a rotation to observe cylinder 3D object 1602 in a side view. According to the present description, user 100 selects a “rotate” portion 215 of viewport 202, which is the graphical user interface (GUI)of application 502. Alternatively, said “rotate” transformation selection is again performed by means of activating a particular key of keyboard 103, wherein the association of said transformation function to said key is known as a “hotkey”.

According to the present description still, pointer 213 is translated onto the pixels representing cylinder 3D object 1602 rasterized onto viewport 202 and a selection input, for instance by means of a mouse click, as described in FIG. 12, such that a target such as target 1201 is calculated therefrom substantially as described in FIGS. 11 and 12. As previously described, the length of a 3D vector such as 3D vector 904 is calculated and, having regard to the fact that the viewport has been translated as described in FIG. 16, said distance is now only one metre.

According to the description of step 1005, the question of step 1301 is answered negatively because a high level of accuracy is now required to rotate from the scene shown in FIG. 16 to the scene shown in FIG. 17. The question of step 1202 is again answered negatively since user 100 has selected object 1602 with pointer 213 for the purpose of said scene navigation. The scaling factor (SF) is therefore calculated as one fiftieth of the one metre distance, i.e. 0.02 scene scale units or two centimetres. Thereafter, according to the description of step 1008, the question of step 1401 is answered negatively and the question of step 1403 is answered positively in regard of the previous “rotate” 215 selection such that input data provided by user 100 by means of mouse 102 is constrained according to the parameters described at step 1404. User 100 thus imparts a horizontal motion to mouse 102 (the x axis thereof) and said input data is incremented according to said (SF) value of two centimetres. In effect, viewport 202 is rotated as shown at 1701 relative to the pivot of cylinder object 1602 along a circle having a radius equal to the 3D vector calculated at step 1104, in increments of two centimetres until such time as the scene has been transformed from the scene shown in FIG. 16 shown in dashed line at 1702 to the scene as shown in FIG. 17. For the purpose of completeness of the present description, it should here be noted that all of the objects in scene 201 have also been transformed by said rotation, thus doorknob object 1602 has similarly been transformed by a rotation transformation and the other doorknob model is now perpendicular to the viewing axis and visually obstructed by doorknob 1501.

Application 502 has thus again automatically scaled the extent of transformation according to the calculated scaling factor (SF), such that the inputting of motion data by user 100 for transforming the scene appears linear to said user: said user 100 is imparting the same amount of motion data to mouse 102 in order to precisely rotate in increments of two centimetres as she was in order to zoom into scene 201 by increments of forty meters, then by increments of four meters.

The invention has been described above with reference to specific embodiments. Persons skilled in the art will recognize, however, that various modifications and changes may be made thereto without departing from the broader spirit and scope of the invention as set forth in the appended claims. The foregoing description and drawings are, accordingly, to be regarded in an illustrative rather than a restrictive sense. The listing of steps in method claims do not imply performing the steps in any particular order, unless explicitly stated in the claim.

1. A computer readable medium storing instructions for causing a computer to scale motion input data during application of a transformation to an object in a three-dimensional volume by performing the steps of:
identifying a target within the volume;
calculating a distance between the target and a position within a viewport, the viewport displaying a two dimensional projection of the volume;
calculating a scaling factor based on the distance;
receiving motion input data; and
processing the motion input data based on the scaling factor.

2. The computer readable medium of claim 1, wherein the scaling factor is a portion of the distance.

3. The computer readable medium of claim 4, wherein the portion is determined based on a camera mode or a perspective mode.

4. The computer readable medium of claim 1, wherein the target is a surface of the object nearest to the viewport intersected by a view axis, the view axis projecting from the position within the viewport through the volume.

5. The computer readable medium of claim 1, further comprising the step of receiving transformation selection data, the transformation selection data specifying a translation operation, a rotation operation, or a scaling operation.

6. The computer readable medium of claim 5, wherein the motion input data is constrained to two dimensions of the three dimensional volume, the two dimensions specified by the transformation selection data.

7. The computer readable medium of claim 5, wherein the processing includes incrementing the motion input data by the scaling factor during application of an operation specified by the transformation selection data.

8. The computer readable medium of claim 1, wherein a second object is selected for processing by the motion input data and the target is a geometric center of the second object intersected by a view axis, the view axis projecting from the position within the viewport through the volume.

9. The computer readable medium of claim 1, wherein the scaling factor is an input data increment for the processing of the motion input data.

10. A method for causing a computer to scale motion input data during application of a transformation to an object in a three-dimensional volume, comprising:
identifying a target within the volume;
calculating a distance between the target and a position within a viewport, the viewport displaying a two dimensional projection of the volume;
calculating a scaling factor based on the distance;
receiving motion input data; and
processing the motion input data based on the scaling factor.

11. The method of claim 10, wherein the scaling factor is a portion of the distance.

12. The method of claim 10, wherein the target is a surface of the object nearest to the viewport intersected by a view axis, the view axis projecting from the position within the viewport through the volume.

13. The method of claim 10, further comprising the step of receiving transformation selection data, the transformation selection data specifying a translation operation, a rotation operation, or a scaling operation.

14. The method of claim 13, wherein the processing includes incrementing the motion input data by the scaling factor during application of an operation specified by the transformation selection data.

15. The method of claim 13, wherein the motion input data is constrained to two dimensions of the three dimensional volume, the two dimensions specified by the transformation selection data.

16. The method of claim 10, wherein a second object is selected for processing by the motion input data and the target is a geometric center of the second object intersected by a view axis, the view axis projecting from the position within the viewport through the volume.

17. The method of claim 10, wherein the scaling factor is an input data increment for the processing of the motion input data.

18. A system for causing a computer to scale motion input data during application of a transformation to an object in a three-dimensional volume, the system comprising:
means for identifying a target within the volume;
means for calculating a distance between the target and a position within a viewport, the viewport displaying a two dimensional projection of the volume;
means for calculating a scaling factor based on the distance;
means for receiving motion input data; and
means for processing the motion input data based on the scaling factor.

19. The system of claim 18, further comprising means for selecting a second object for processing by the motion input data.

20. The system of claim 18, further comprising means for incrementing the motion input data by the scaling factor during application of an operation specified by transformation selection data.
